(19) United States
(12) Patent Application Publication
(10) Pub. No.: US 2025/0094239 A1
(43) Pub. Date: Mar. 20, 2025

(54) RESOURCE MANAGEMENT DEVICE AND RESOURCE MANAGEMENT METHOD

(71) Applicant: Mitsubishi Electric Corporation, Tokyo (JP)

(72) Inventor: Yusuke SETO, Tokyo (JP)

(73) Assignee: Mitsubishi Electric Corporation, Tokyo (JP)

(21) Appl. No.: 18/728,895

(22) PCT Filed: Feb. 1, 2022
(86) PCT No.: PCT/JP2022/003706

§ 371 Date: Jul. 15, 2024

(51) Int. Cl. G06F 9/50

(52) U.S. Cl. CPC G06F 9/5077; G06F 9/5011; G06F 2209/503

(57) ABSTRACT

A resource management device includes a data acquiring unit to acquire monitoring data indicating a temporal change in a use amount of a resource used in the past by each of containers included in a node among resources of the node, a prediction unit to predict a temporal change in a use amount of the resource to be used in the future by the container from each of pieces of the monitoring data, and calculate a temporal change in a total use amount of the resource to be used in the future by the containers from the prediction result, and a container deleting unit to delete one of the containers when a timing at which the total use amount of the resource becomes larger than the total of the resources of the node is included in the temporal change in the total use amount of the resource.

### TECHNICAL FIELD

The present disclosure relates to a resource management device and a resource management method.

### BACKGROUND ART

There is a node including one or more containers. The node is a computer on which one operating system (OS) operates. The container causes an application to be executed using computer resources (hereinafter referred to as “resources”) of the node. The node has finite resources. Thus, it is useful to determine the one or more containers included in the node in such a manner that a total of resources used by the containers is not larger than a total of resources of the node.

There is a method of determining whether a container can be mounted (see, for example, Patent Literature 1). A method disclosed in Patent Literature 1 manages, as to one or more containers, respective usage states of resources, and determines a container included in a node on the basis of the respective usage states of resources so as not to exceed a total of resources of the node. The usage state of resources indicates a temporal change in a use amount of the resources used by the container in the past. The use amount of the resources may vary over time.

### CITATION LIST

### Patent Literatures

Patent Literature 1: JP 2020-52730 A

### SUMMARY OF INVENTION

### Technical Problem

A variation in the use amount of resources may be different for each container. Under a situation where the variation in the use amount of resources is different for each container, a time at which the use amount of resources reaches a peak (hereinafter referred to as a “peak time”) may be different for each container, In a case where the peak time is different for each container, if the container included in the node is determined on the basis of respective peak values of the use amount of resources, a large portion of resources of the node may be unused.

On the other hand, peak times of all the containers included in the node or some of the containers included in the node may overlap depending on respective variation states of the use amount of resources. When the containers included in the node are determined on the basis of the respective use amounts of resources at a freely-selected time in a case where the peak times overlap, a total of the use amounts of resources by all the containers included in the node may become larger than the total of the resources of the node in the future.

In the method disclosed in Patent Literature 1, nodes included in a node are determined on the basis of the respective usage states of resources. However, there is a problem that the nodes included in the node are not determined on the basis of respective variation states of the use amount of resources. Thus, a situation in which a large portion of resources of the node is unused or a situation in which the total of the use amounts of resources by all the containers included in the node becomes larger than the total of the resources of the node in the future may occur.

The present disclosure has been made to solve the problem as described above, and an object of the present disclosure is to obtain a resource management device and a resource management method capable of suppressing a total of use amounts of resources by all containers included in a node to be equal to or less than a total of resources of the node while suppressing a surplus of the resources of the node.

### Solution to Problem

A resource management device according to the present disclosure includes a data acquiring unit to acquire monitoring data indicating a temporal change in a use amount of a resource used in the past by each of one or more containers included in a node among at least one resource of the node, and a prediction unit to predict a temporal change in a use amount of the resource to be used in the future by each of the containers from a corresponding one of pieces of the monitoring data acquired by the data acquiring unit, and calculate a temporal change in a total use amount of the resource to be used in the future by the one or more containers from a prediction result of the temporal change, Further, the resource management device includes a container deleting unit to delete one of the one or more containers when a timing at which the total use amount of the resource becomes larger than a total of the resource of the node is included in the temporal change in the total use amount of the resource calculated by the prediction unit.

### Advantageous Effects of Invention

According to the present disclosure, it is possible to suppress a total of use amounts of resources by all containers included in a node to be equal to or less than a total of resources of the node while suppressing a surplus of the resources of the node.

### BRIEF DESCRIPTION OF DRAWINGS

FIG. 1 is a configuration diagram illustrating a node 2 including a resource management device 12 according to a first embodiment.

FIG. 2 is a configuration diagram illustrating the resource management device 12 according to the first embodiment.

FIG. 3 is a hardware configuration diagram illustrating hardware of the resource management device 12 according to the first embodiment,

FIG. 4 is a hardware configuration diagram of a computer in a case where the resource management device 12 is implemented by software, firmware, or the like.

FIG. 5 is a flowchart illustrating a resource management method which is a processing procedure performed in the resource management device 12.

FIG. 6 is an explanatory diagram illustrating monitoring data related to a container 11-n (n=1, 2, and 3), a prediction result by a prediction unit 32, and a total resource use amount.

FIG, 7 is a configuration diagram illustrating a resource management device 12 according to a second embodiment.

FIG. 8 is a hardware configuration diagram illustrating hardware of the resource management device 12 according to the second embodiment.

FIG. 9 is a configuration diagram illustrating a resource management device 12 according to a third embodiment.

FIG. 10 is a hardware configuration diagram illustrating hardware of the resource management device 12 according to the third embodiment.

FIG. 11 is an explanatory diagram illustrating an example in which a prediction unit 36 extracts, from each piece of monitoring data MD₁ to MD_{N}, a part of the data when an operating state of the node 2 is a same state.

### DESCRIPTION OF EMBODIMENTS

Hereinafter, in order to describe the present disclosure in more detail, modes for carrying out the present disclosure will be described with reference to the accompanying drawings.

### First Embodiment

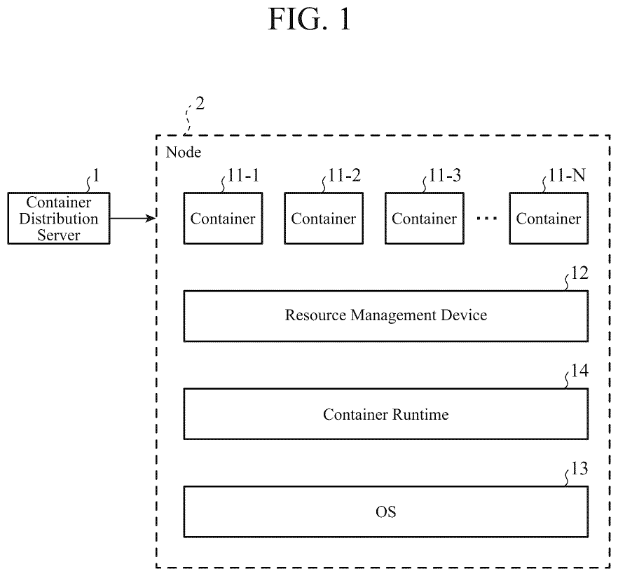

FIG. 1 is a configuration diagram illustrating a node 2 including a resource management device 12 according to a first embodiment.

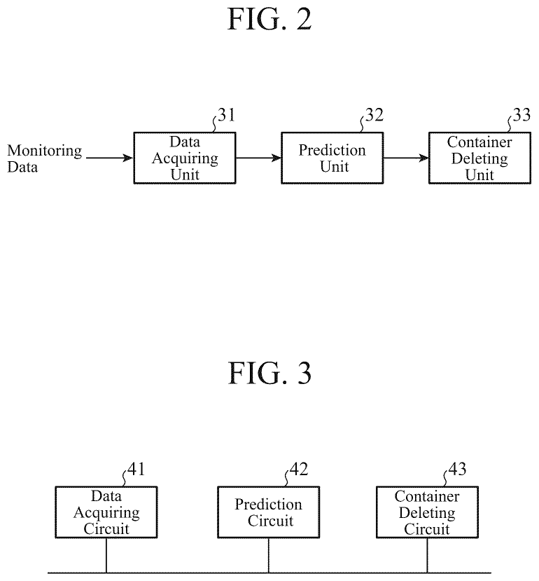

FIG. 2 is a configuration diagram illustrating the resource management device 12 according to the first embodiment.

FIG. 3 is a hardware configuration diagram illustrating hardware of the resource management device 12 according to the first embodiment.

In FIG. 1, a container distribution server 1 is a server for distributing a container 11-n (n=1, . . . , N) to the node 2. N is an integer equal to or more than 1.

The node 2 is connected to the container distribution server 1 via a network.

The node 2 is a computer on which one operating system (OS) operates.

The node 2 includes containers 11-1 to 11-N distributed from the container distribution server 1 and the resource management device 12.

Further, the node 2 includes an OS 13 and a container runtime 14.

The node 2 illustrated in FIG. 1 includes the resource management device 12. However, this is merely an example, and the resource management device 12 may be provided outside the node 2.

The container 11-n (n=1, . . . , N) is an execution environment of an application. A resource on which the application operates is a resource virtually separated from resources managed by the OS 13.

Virtual separation of resources is performed by the container runtime 14 using a function held by the OS 13.

An example of the resources is a central processing unit (CPU) included in the node 2, a memory included in the node 2, a storage included in the node 2, a network connected to the node 2, or an external device connected to the node 2. An example of the external device is a printer, a communication device, or a sensor,

The resource management device 12 includes a data acquiring unit 31, a prediction unit 32, and a container deleting unit 33.

The OS 13 is located between an application program and hardware, and manages the resources of the node 2. Further, the OS 13 provides a standard interface for the application program.

The container runtime 14 virtually separates the resources of the node 2 by using a function held by the OS 13.

Further, the container runtime 14 provides the virtually separated resources to the container 11-n (n=1, . . . , N).

Furthermore, the container runtime 14 outputs, to the data acquiring unit 31 of the resource management device 12, monitoring data MDₙ indicating a temporal change in a use amount of a resource used in the past by the container 11-n.

The data acquiring unit 31 is implemented by, for example, a data acquiring circuit 41 illustrated in FIG. 3.

The data acquiring unit 31 acquires, from the container runtime 14, the monitoring data MDₙ indicating a temporal change in a use amount of a resource used in the past by the container 11-n (n=1, . . . , N) among the resources of the node 2.

The data acquiring unit 31 outputs the monitoring data MDₙ to the prediction unit 32.

The prediction unit 32 is implemented by, for example, a prediction circuit 42 illustrated in FIG. 3.

The prediction unit 32 acquires the monitoring data MDₙ from the data acquiring unit 31.

The prediction unit 32 predicts, from the monitoring data MDₙ, temporal change in a use amount of a resource to be used in the future by the container 11-n.

The prediction unit 32 calculates, from the prediction result of the temporal change, a temporal change in a total use amount of resources to be used in the future by the containers 11-1 to 11-N.

The container deleting unit 33 is implemented by, for example, a container deleting circuit 43 illustrated in FIG. 3.

The container deleting unit 33 determines whether or not a timing at which the total use amount of resources becomes larger than a total of the resources of the node 2 is included in the temporal change in the total use amount of resources calculated by the prediction unit 32.

When it is determined that the timing is included, the container deleting unit 33 deletes one of the containers 11-1 to 11-N.

When it is determined that the timing is not included, the container deleting unit 33 does not delete any of the containers 11-1 to 11-N.

In FIG. 2, it is assumed that each of the data acquiring unit 31, the prediction unit 32, and the container deleting unit 33 which are components of the resource management device 12 is implemented by dedicated hardware as illustrated in FIG. 2. That is, it is assumed that the resource management device 12 is implemented by the data acquiring circuit 41, the prediction circuit 42, and the container deleting circuit 43.

Each of the data acquiring circuit 41, the prediction circuit 42, and the container deleting circuit 43 corresponds to, for example, a single circuit, a composite circuit, a programmed processor, a parallel-programmed processor, an application specific integrated circuit (ASIC), a field-programmable gate array (FPGA), or a combination thereof,

The components of the resource management device 12 are not limited to those implemented by dedicated hardware, and the resource management device 12 may be implemented by software, firmware, or a combination of software and firmware.

The software or firmware is stored in a memory of a computer as a program. The computer means hardware that executes a program, and corresponds to, for example, a CPU, a central processing device, a processing device, an arithmetic device, a microprocessor, a microcomputer, a processor, or a digital signal processor (DSP).

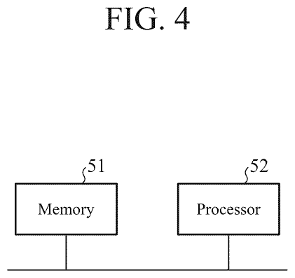

FIG. 4 is a hardware configuration diagram of a computer in a case where the resource management device 12 is implemented by software, firmware, or the like.

In a case where the resource management device 12 is implemented by software, firmware, or the like, a program for causing a computer to execute each processing procedure performed in the data acquiring unit 31, the prediction unit 32, and the container deleting unit 33 is stored in a memory 51. Then, a processor 52 of the computer executes the program stored in the memory 51.

Further, FIG. 3 illustrates an example in which each of the components of the resource management device 12 is implemented by dedicated hardware, and FIG. 4 illustrates an example in which the resource management device 12 is implemented by software, firmware, or the like, However, this is merely an example, and some components in the resource management device 12 may be implemented by dedicated hardware, and the remaining components may be implemented by software, firmware, or the like.

Next, an operation of the resource management device 12 illustrated in FIG. 2 will be described.

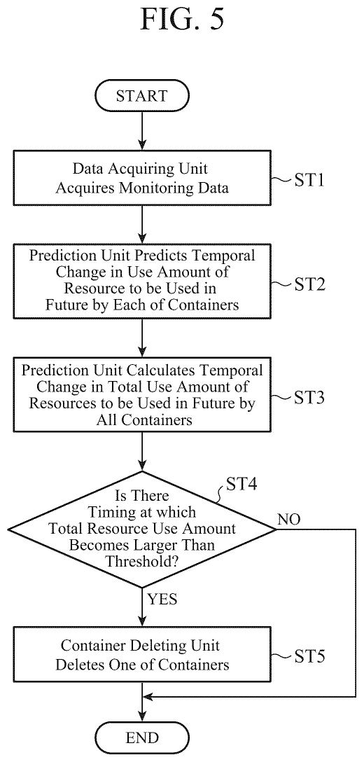

FIG. 5 is a flowchart illustrating a resource management method which is a processing procedure performed in the resource management device 12.

The node 2 includes the containers 11-1 to 11-N distributed from the container distribution server 1.

Here, in order to simplify the description, processing to determine, at a time when any container of the containers 11-1 to 11-N is distributed from the container distribution server 1, whether or not to mount the distributed container on the node 2 will be described later.

The data acquiring unit 31 acquires, from the container runtime 14 of the node 2, the monitoring data MDₙ indicating the temporal change in the use amount of the resource used in the past by the container 11-n (n=1, . . . , N) among the resources of the node 2 (step ST1 in FIG. 5).

A use amount of the resource of the node 2 is, for example, a use rate of a CPU included in the node 2, a use amount of a memory included in the node 2, a use amount of a storage included in the node 2, a bandwidth use rate of a network connected to the node 2, or a use rate of a device connected to the node 2.

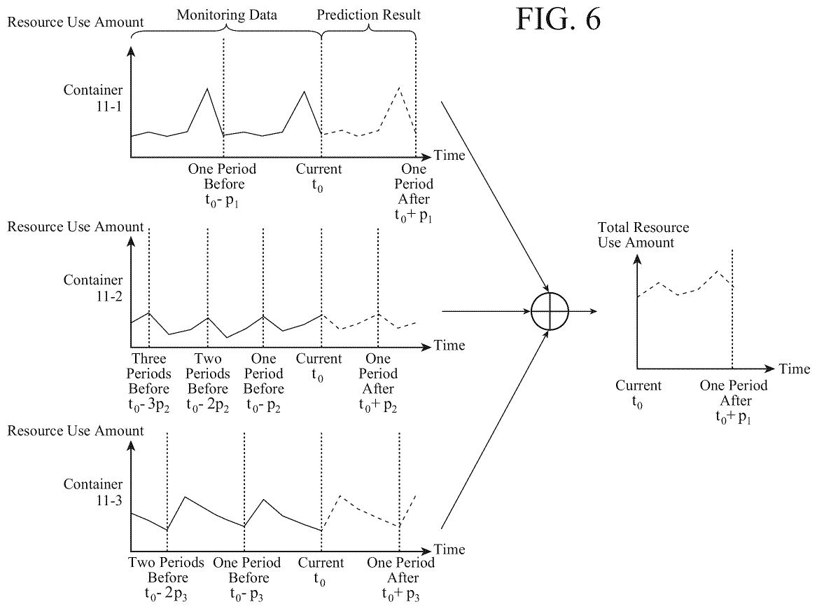

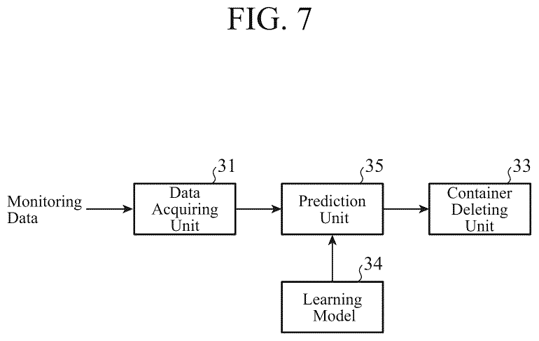

FIG. 6 is an explanatory diagram illustrating monitoring data related to the container 11-n (n=1, 2, and 3), a prediction result by the prediction unit 32, and a total resource use amount.

The data acquiring unit 31 outputs the monitoring data MDₙ to the prediction unit 32.

The prediction unit 32 acquires the monitoring data MDₙ (n=1, . . . , N) from the data acquiring unit 31.

The prediction unit 32 predicts, from the monitoring data MDₙ, a temporal change in the use amount of the resource to be used in the future by the container 11-n (step ST2 in FIG. 5).

Hereinafter, prediction processing performed in the prediction unit 32 will be specifically described.

The prediction unit 32 acquires, from the monitoring data MDₙ, a use amount uₙ(t) of a resource at a certain time t and a use amount uₙ(t+τ) of the resource at a time (t+τ) later than the time t by a delay time τ.

The prediction unit 32 calculates an autocorrelation function Rₙ(τ) for the use amount of the resource, from the use amount uₙ(t) of the resource and the use amount uₙ(t+τ) of the resource. Since the calculation processing of the autocorrelation function Rₙ(τ) itself is a known technique, detailed description thereof will be omitted.

The prediction unit 32 calculates M autocorrelation functions Rₙ(τ) by changing the delay time τ. M is an integer equal to or more than 2. Hereinafter, the M autocorrelation functions Rₙ(τ) are expressed as R_{n,m}(τ). Here, m=1, . . . , M.

The prediction unit 32 specifies, as a period pₙ of the use amount of the resource used in the past by the container 11-n, the delay time τ of the autocorrelation function R_{n,m}(τ) having the highest positive correlation among M autocorrelation functions R_{n,m}(τ).

The prediction unit 32 predicts the temporal change in the use amount of the resource to be used in the future by the container 11-n on the basis of the temporal change in the use amount within the period pₙ.

Specifically, the prediction unit 32 predicts that the temporal change in the use amount of the resource used by the container 11-n from a time (t₀−pₙ·j) that is j periods before the current time t₀ to a time (t₀−pₙ·(j−1)) that is (j−1) periods before the current time t₀ is a temporal change in the use amount of the resource to be used by the container 11-n from a time (t₀+pₙ(i−1)) that is (i−1) periods after the current time t₀ to a time (t₀+pₙ·i) that is i periods after the current time t₀. Each of i and j is an integer equal to or more than 1.

In the example of FIG. 6, the prediction unit 32 predicts that the temporal change in the use amount of the resource used by the container 11-n (n=1, 2, and 3) from a time one period before the current time t₀ to the current time t₀ is a temporal change in the use amount of the resource to be used by the container 11-n from the current time t₀ to a time one period after the current time t₀.

Here, the prediction unit 32 predicts the temporal change in the use amount of the resource for one period. However, this is merely an example, and the prediction unit 32 may predict the temporal change in the use amount of the resource for a plurality of periods on the basis of the temporal change in the use amount within the period pₙ.

In the resource management device 12 illustrated in FIG. 2, the prediction unit 32 calculates the M autocorrelation functions R_{n,m}(τ) by changing the delay time τ. The change width of the delay time τ is set to such a granularity that the period pₙ of the use amount can be specified. That is, the sampling frequency for monitoring the temporal change in the use amount of the resource is set in such a manner that the assumed maximum value of the change frequency of the use amount of the resource used by the container 11-n is sufficiently lower than the Nyquist frequency,

In the resource management device 12 illustrated in FIG. 2, assuming that there is periodicity in the use amount of the resource used in the past, the prediction unit 32 predicts the temporal change in the use amount of the resource to be used in the future by the container 11-n on the basis of the temporal change in the use amount within the period pₙ.

However, in some cases, there is no periodicity in the use amount of the resource used in the past by the container 11-n. In a case where there is no periodicity in the use amount of the resource, each of the M autocorrelation functions R_{n,1}(τ) to R_{n,M}(τ) is approximately 0.

When there is no periodicity in the use amount of the resource, the prediction unit 32 predicts a temporal change in the use amount of the resource to be used in the future by the container 11-n on the basis of the peak value of the use amount of the resource used in the past by the container 11-n.

That is, the prediction unit 32 predicts that the use amount of the resource to be used in the future by the container 11-n has a continuous peak value of the use amount of the resource used in the past.

The prediction unit 32 calculates, from a prediction result of the temporal change, the temporal change in the total use amount of the resource to be used in the future by the containers 11-1 to 11-N (step ST3 in FIG. 5).

Hereinafter, calculation processing by the prediction unit 32 will be specifically described.

The prediction unit 32 compares the periods p₁ to p_{N} of the use amount of the resource used in the past by the containers 11-1 to 11-N with each other, and specifies a longest period pₘₐₓ among the periods p₁ to p_{N}. Here, for convenience of description, it is assumed that the container related to the longest period pₘₐₓ is the container 11-1.

The prediction unit 32 specifies a use amount u₁(t) of a resource to be used from the current time t₀ to a time t₀+p₁, which is one period after the current time, among the use amounts of the resource to be used in the future by the container 11-1, t₀≤t≤t₀+p₁=t₀+pₘₐₓ.

The prediction unit 32 specifies a use amount uₙ(t) of a resource to be used from the current time t₀ to the time t₀+p₁ among the use amounts of the resource to be used in the future by the container 11-n (n=2, . . . , N).

The prediction unit 32 calculates a total resource use amount uₜₒₜₐₗ(t) which is a total of use amounts u₁(t) to u_{N}(t) of the resource as expressed in the following expression (1).

uₜₒₜₐₗ(t)=u₁(t)+ . . . +u_{N}(t) (1)

In the example of FIG. 6, the prediction unit 32 calculates the total resource use amount uₜₒₜₐₗ(t) which is a total of use amounts u₁(t) to u₃(t) of the resource.

The prediction unit 32 outputs the total resource use amount uₜₒₜₐₗ(t) to the container deleting unit 33 as a temporal change in the total use amount of the resource.

In the resource management device 12 illustrated in FIG. 2, the total resource use amount uₜₒₜₐₗ(t) is the total of the use amounts u₁(t) to u₃(t) of the resource to be used from the current time t₀ to the time t₀+p₁. However, this is merely an example, and the total resource use amount uₜₒₜₐₗ(t) may be the total of the use amounts u₁(t) to u₃(t) of the resource to be used from the current time t₀ to the time t₀+k×p₁. k is an integer equal to or more than 2.

The container deleting unit 33 acquires the total resource use amount uₜₒₜₐₗ(t) from the prediction unit 32.

For example, the container deleting unit 33 determines whether or not there is a timing at which the total resource use amount uₜₒₜₐₗ(t) becomes larger than a threshold Th between the current time t₀ and the time t₀+p₁. The threshold Th indicates the total of the resources of the node 2. The threshold Th may be stored in the internal memory of the container deleting unit 33 or may be given from the outside of the resource management device 12.

When there is a timing at which the total resource use amount uₜₒₜₐₗ(t) becomes larger than the threshold Th between the current time t₀ and the time t₀+p₁ (in the case of step ST4; YES in FIG. 5), the container deleting unit 33 determines that a resource use amount larger than the total of the resources of the node 2 is included in the total resource use amount uₜₒₜₐₗ(t).

When there is no timing at which the total resource use amount uₜₒₜₐₗ(t) becomes larger than the threshold Th between the current time t₀ and the time t₀+p₁ (in the case of step ST4: NO in FIG. 5), the container deleting unit 33 determines that the resource use amount larger than the total of the resources of the node 2 is not included in the total resource use amount uₜₒₜₐₗ(t).

When it is determined that the resource use amount larger than the total of the resources of the node 2 is included in the total resource use amount uₜₒₜₐₗ(t), the container deleting unit 33 deletes one of the containers 11-1 to 11-N (step ST5 in FIG. 5).

Hereinafter, container deletion processing by the container deleting unit 33 will be specifically described.

When it is determined that the resource use amount larger than the total of the resources of the node 2 is included in the total resource use amount uₜₒₜₐₗ(t), the container deleting unit 33 specifies a use amount uₙ(Tim) of a resource to be used by the container 11-n at a time Tim when the resource use amount becomes larger than the total of the resources of the node 2,

The container deleting unit 33 specifies a largest use amount uₘₐₓ(Tim) of a resource among the use amounts u₁(Tim) to u_{N}(Tim) of the resource to be used by the containers 11-1 to 11-N, respectively.

The container deleting unit 33 deletes a container related to the largest use amount uₘₐₓ(Tim) of the resource among the containers 11-1 to 11-N.

If the total resource use amount uₜₒₜₐₗ(Tim) is larger than the threshold Th even when the container related to the largest use amount uₘₐₓ(Tim) of the resource is deleted, the container deleting unit 33 further deletes the container related to the second largest use amount of a resource.

The container deleting unit 33 deletes the containers in descending order of the use amount of the resource until the total resource use amount uₜₒₜₐₗ(Tim) becomes equal to or less than the threshold Th.

When it is determined that the timing does not exist, the container deleting unit 33 does not perform the container deletion processing.

In the resource management device 12 illustrated in FIG. 2, the container deleting unit 33 deletes the container. However, this is merely an example, and the container deleting unit 33 may request the container runtime 14 to delete the container, and the container runtime 14 may delete the container,

In the resource management device 12 illustrated in FIG. 2, the container deleting unit 33 determines a container to be deleted on the basis of the use amount uₙ(Tim) of the resource at the time Tim. However, this is merely an example, and the container deleting unit 33 may determine the container to be deleted on the basis of, for example, a time tdₙ at which each of the containers 11-1 to 11-N is distributed from the container distribution server 1 to the node 2. For example, the container deleting unit 33 determines a container whose time tdₙ of distribution to the node 2 is closest to the current time t₀ among the containers 11-1 to 11-N as the container to be deleted.

In the resource management device 12 illustrated in FIG. 2, the container deleting unit 33 determines a container to be deleted on the basis of the use amount uₙ(Tim) of the resource at the time Tim. However, this is merely an example, and the container deleting unit 33 may determine the container to be deleted on the basis of an operation priority wₙ of the container 11-n, for example. For example, the container deleting unit 33 determines a container having the smallest operation priority wₙ among the containers 11-1 to 11-N as the container to be deleted. The operation priority wₙ of the container 11-n may be stored in the internal memory of the container deleting unit 33 or may be given from the outside of the resource management device 12.

Further, the container deleting unit 33 calculates a cost CSTₙ of the container 11-n by performing weighted addition or the like of the use amount uₙ(Tim) of the resource at the time Tim, the time tdₙ of distribution to the node 2, and the operation priority wₙ of the container 11-n. The cost CSTₙ is larger as the use amount uₙ(Tim) of the resource is larger, is larger as the time tdₙ of distribution to the node 2 is closest to the current time t₀, and is larger as the operation priority wₙ is smaller.

Then, the container deleting unit 33 may determine the container having the largest cost CSTₙ among the containers 11-1 to 11-N as the container to be deleted.

In the first embodiment described above, the resource management device 12 is configured to include the data acquiring unit 31 that acquires monitoring data indicating the temporal change in the use amount of a resource used in the past by each of one or more containers 11-n (n=1, . . . , N) included in the node 2 among the resources of the node 2, and the prediction unit 32 that predicts the temporal change in the use amount of a resource to be used in the future by the container 11-n from the corresponding one pieces of the monitoring data acquired by the data acquiring unit 31 and calculates the temporal change in the total use amount of the resource to be used in the future by the containers 11-1 to 11-N from the prediction result of the temporal change. Further, the resource management device 12 includes the container deleting unit 33 that deletes one of the containers 11-1 to 11-N when a timing at which the total use amount of the resource becomes larger than the total of the resources of the node 2 is included in the temporal change in the total use amount of the resource calculated by the prediction unit 32. Therefore, the resource management device 12 can suppress the total of the resource use amounts by the containers 11-1 to 11-N included in the node 2 to be equal to or less than the total of the resources of the node 2 while suppressing the surplus of the resources of the node 2.

The node 2 illustrated in FIG. 1 includes the containers 11-1 to 11-N. The node 2 may receive a new container 11-(N+1) different from the containers 11-1 to 11-N from the container distribution server 1 and include the containers 11-1 to 11-(N+1).

When the new container 11-(N+1) is a container that the node 2 has never included in the past, the data acquiring unit 31 of the resource management device 12 acquires a scheduled use amount of the resource used by the new container 11-(N+1) from the container distribution server 1.

The container deleting unit 33 adds a temporal average value of the total resource use amount by the containers 11-1 to 11-N and the scheduled use amount of the resource used by the new container 11-(N+1).

Then, the container deleting unit 33 determines whether or not an addition result of the temporal average value and the scheduled use amount is equal to or less than the total of the resources of the node 2.

When the addition result is equal to or less than the total of the resources of the node 2, the container deleting unit 33 outputs a permission command indicating that it is permitted to include the new container 11-(N+1) to the container runtime 14. Thus, the container runtime 14 causes the node 2 to include the containers 11-1 to 11-N and also include the container 11-(N+1).

When the addition result is larger than the total of the resources of the node 2, the container deleting unit 33 outputs a non-permission command indicating that it is not permitted to include the new container 11-(N+1) to the container runtime 14. Thus, the container runtime 14 causes the node 2 to include only the containers 11-1 to 11-N.

When the new container 11-(N+1) is a container that the node 2 has included in the past, the prediction unit 32 may predict a temporal change in the use amount of the resource to be used in the future by the container 11-(N+1), similarly to the containers 11-1 to 11-N.

Then, the prediction unit 32 calculates a temporal change in the total use amount of the resource to be used in the future by the containers 11-1 to 11-(N+1).

When the temporal change in the total use amount of the resource calculated by the prediction unit 32 does not include a timing at which the total use amount of the resource becomes larger than the total of the resources of the node 2, the container deleting unit 33 outputs a permission command indicating that it is permitted to include the new container 11-(N+1) to the container runtime 14. Thus, the container runtime 14 causes the node 2 to include the containers 11-1 to 11-N and also include the container 11-(N+1).

When the temporal change in the total use amount of the resource calculated by the prediction unit 32 includes a timing at which the total use amount of the resource becomes larger than the total of the resources of the node 2, the container deleting unit 33 outputs a non-permission command indicating that it is not permitted to include the new container 11-(N+1) to the container runtime 14. Thus, the container runtime 14 causes the node 2 to include only the containers 11-1 to 11-N.

In the resource management device 12 illustrated in FIG. 2, the prediction unit 32 calculates the temporal change in the total use amount of the resource to be used in the future by the containers 11-1 to 11-N. However, this is merely an example, and the temporal change in the total use amount of the resource to be used in the future by some of the containers 11-1 to 11-N may be calculated.

Specifically, it is as follows.

The prediction unit 32 detects a container having no periodicity in the use amount of the resource among the containers 11-1 to 11-N. In the container having no periodicity in the use amount of the resource, each of the M autocorrelation functions R_{n,1}(τ) to R_{n,M}(τ) is substantially 0 even if the delay time τ is changed.

In a case where there are H containers having no periodicity in the use amount of the resource, the prediction unit 32 calculates a correlation coefficient C between the use amounts of the resource used in the past by the respective H containers so as not to include the use amount of the resource to be used in the future by a container other than one container among the H containers in the total use amount of the resource. H is an integer equal to or more than 2, and H≤N.

Among the containers 11-1 to 11-N, when containers having no periodicity in the use amount of the resource are, for example, the containers 11-1 and 11-2, a correlation coefficient C₁₋₂ between the use amount of the resource used in the past by the container 11-1 and the use amount of the resource used in the past by the container 11-2 is calculated. Since the calculation processing for the correlation coefficient C₁₋₂ itself is a known technique, detailed description thereof will be omitted.

When the correlation coefficient C₁₋₂ is a negative correlation, the prediction unit 32 specifies a container having the highest peak value of the use amount of the resource used in the past among the containers 11-1 and 11-2,

For example, when the container having the highest peak value is the container 11-1, the prediction unit 32 specifies the use amount u₁(t) of the resource as the temporal change in the use amount of the resource to be used in the future by the container 11-1. The use amount u₁(t) of the resource has a continuous peak value of the use amount of the resource used in the past by the container 11-1.

The prediction unit 32 does not specify the use amount u₂(t) of the resource to be used in the future by the container 11-2 which is a container other than the container having the highest peak value.

When calculating the total resource use amount uₜₒₜₐₗ(t), the prediction unit 32 includes the use amount u₁(t) of the resource to be used in the future by the container 11-1 in the total resource use amount uₜₒₜₐₗ(t), but does not include the use amount u₂(t) of the resource to be used in the future by the container 11-2.

When the correlation coefficient C₁₋₂ between the use amount of the resource used in the past by the container 11-1 and the use amount of the resource used in the past by the container 11-2 is a negative correlation, it is unlikely that the container 11-1 and the container 11-2 use the resource at the same timing. Thus, the prediction unit 32 does not include the use amount u₂(t) of the resource to be used in the future by the container 11-2 in the total resource use amount uₜₒₜₐₗ(t).

Here, an example is illustrated in which, among the containers 11-1 to 11-N, containers having no periodicity in the use amount of the resource are the containers 11-1 and 11-2. However, this is merely an example, and there may be three or more containers having no periodicity in the use amount of the resource. For example, it is assumed that containers having no periodicity in the use amount of the resource are containers 11-1 to 11-3.

In this case, the prediction unit 32 calculates the correlation coefficient C₁₋₂ between the use amount of the resource used in the past by the container 11-1 and the use amount of the resource used in the past by the container 11-2, and calculates a correlation coefficient C₂₋₃ between the use amount of the resource used in the past by the container 11-2 and the use amount of the resource used in the past by the container 11-3.

Further, the prediction unit 32 calculates a correlation coefficient C₃₋₁ between the use amount of the resource used in the past by the container 11-3 and the use amount of the resource used in the past by the container 11-1.

When each of the correlation coefficients C₁₋₂, C₂₋₃, and C₃₋₁ has a negative correlation, the prediction unit 32 specifies a container having the highest peak value of the use amount of the resource used in the past among the containers 11-1 to 11-3.

For example, when the container having the highest peak value is the container 11-1, the prediction unit 32 specifies the use amount u₁(t) of the resource as the temporal change in the use amount of the resource to be used in the future by the container 11-1, The use amount u₁(t) of the resource has a continuous peak value of the use amount of the resource used in the past by the container 11-1.

The prediction unit 32 does not specify the use amounts u₂(t) and u₃(t) of the resource to be used in the future by the respective containers 11-2 and 11-3 which are containers other than the container having the highest peak value.

When calculating the total resource use amount uₜₒₜₐₗ(t), the prediction unit 32 includes the use amount u₁(t) of the resource to be used in the future by the container 11-1 in the total resource use amount uₜₒₜₐₗ(t), but does not include the use amounts u₂(t) and u₃(t) of the resource to be used in the future by the respective containers 11-2 and 11-3.

### Second Embodiment

In a second embodiment, a resource management device 12 in which a prediction unit 35 acquires a prediction result of a temporal change in the use amount of the resource to be used in the future by the container 11-n (n=1, . . . , N) from a learning model 34 will be described.

FIG. 7 is a configuration diagram illustrating the resource management device 12 according to the second embodiment. In FIG. 7, the same reference numerals as those in FIG. 2 denote the same or corresponding parts, and thus description thereof is omitted.

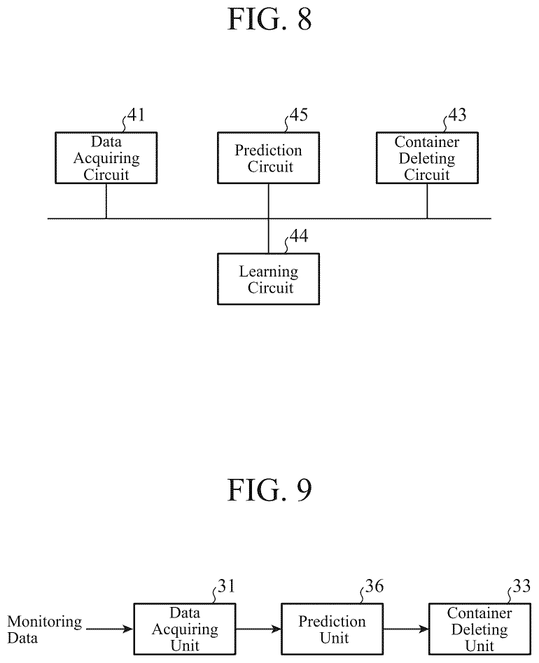

FIG. 8 is a hardware configuration diagram illustrating hardware of the resource management device 12 according to the second embodiment. In FIG. 8, the same reference numerals as those in FIG. 3 denote the same or corresponding parts, and thus description thereof is omitted.

The resource management device 12 illustrated in FIG. 7 includes a data acquiring unit 31, the learning model 34, the prediction unit 35, and a container deleting unit 33.

The configuration of the node 2 including the resource management device 12 illustrated in FIG. 7 is similar to the configuration of the node 2 including the resource management device 12 illustrated in FIG. 2, and the configuration diagram illustrating the node 2 including the resource management device 12 illustrated in FIG. 7 is FIG. 1.

The learning model 34 is implemented by, for example, a learning circuit 44 illustrated in FIG. 8.

At the time of learning, monitoring data MDₙ indicating a temporal change in the use amount of the resource used in the past by the container 11-n (n=1, . . . , N) and training data GDₙ indicating a temporal change in the use amount of the resource to be used in the future by the container 11-n are given to the learning model 34. Then, the learning model 34 learns the temporal change in the use amount of the resource to be used in the future by the container 11-n.

At the time of inference, when the monitoring data MDₙ indicating the temporal change in the use amount of the resource used in the past by the container 11-n is given, the learning model 34 outputs a prediction result indicating the temporal change in the use amount of the resource to be used in the future by the container 11-n.

The prediction unit 35 is implemented by, for example, a prediction circuit 45 illustrated in FIG. 8.

The prediction unit 35 acquires the monitoring data MDₙ (n=1, . . . , N) from the data acquiring unit 31.

The prediction unit 35 gives the monitoring data MDₙ to the learning model 34 and acquires, from the learning model 34, a prediction result indicating the temporal change in the use amount of the resource to be used in the future by the container 11-n.

Similarly to the prediction unit 32 illustrated in FIG. 2, the prediction unit 35 calculates, from the prediction result of the temporal change, the temporal change in the total use amount of the resource to be used in the future by the containers 11-1 to 11-N,

In the resource management device 12 illustrated in FIG. 7, the learning model 34 is provided outside the prediction unit 35. However, this is merely an example, and the prediction unit 35 may include the learning model 34.

In FIG. 7, it is assumed that each of the data acquiring unit 31, the learning model 34, the prediction unit 35, and the container deleting unit 33, which are components of the resource management device 12, is implemented by dedicated hardware as illustrated in FIG. 8. That is, it is assumed that the resource management device 12 is implemented by the data acquiring circuit 41, the learning circuit 44, the prediction circuit 45, and the container deleting circuit 43.

Each of the data acquiring circuit 41, the learning circuit 44, the prediction circuit 45, and the container deleting circuit 43 corresponds to, for example, a single circuit, a composite circuit, a programmed processor, a parallel-programmed processor, ASIC, FPGA, or a combination thereof.

The components of the resource management device 12 are not limited to those implemented by dedicated hardware, and the resource management device 12 may be implemented by software, firmware, or a combination of software and firmware.

In a case where the resource management device 12 is implemented by software, firmware, or the like, a program for causing a computer to execute each processing procedure performed in the data acquiring unit 31, the learning model 34, the prediction unit 35, and the container deleting unit 33 is stored in the memory 51 illustrated in FIG. 4. Then, the processor 52 illustrated in FIG. 4 executes the program stored in the memory 51.

Furthermore, FIG. 8 illustrates an example in which each of the components of the resource management device 12 is implemented by dedicated hardware, and FIG. 4 illustrates an example in which the resource management device 12 is implemented by software, firmware, or the like. However, this is merely an example, and some components in the resource management device 12 may be implemented by dedicated hardware, and the remaining components may be implemented by software, firmware, or the like.

Next, an operation of the resource management device 12 illustrated in FIG. 7 will be described. Since components other than the learning model 34 and the prediction unit 35 are similar to those of the resource management device 12 illustrated in FIG. 2, only operations of the learning model 34 and the prediction unit 35 will be described here.

At the time of learning, the monitoring data MDₙ indicating the temporal change in the use amount of the resource used in the past by the container 11-n (n=1, . . . , N) and the training data GDₙ indicating the temporal change in the use amount of the resource to be used in the future by the container 11-n are given to the learning model 34.

If the learning model 34 is, for example, a learning model including a neural network, the learning model 34 updates a weighting factor of the neural network in such a manner that output data ODₙ indicating a prediction result when the monitoring data MDₙ is given becomes the temporal change in the use amount indicated by the training data GDₙ.

The prediction unit 35 acquires, from the data acquiring unit 31, the monitoring data MDₙ indicating the temporal change in the use amount of the resource used in the past by the container 11-n (n=1, . . . , N).

The prediction unit 35 provides the monitoring data MDₙ to the learning model 34.

When the monitoring data MDₙ is given, the learning model 34 outputs the output data ODₙ indicating a prediction result corresponding to the monitoring data MDₙ.

The prediction unit 35 acquires the output data ODₙ indicating the prediction result from the learning model 34.

Similarly to the prediction unit 32 illustrated in FIG. 2, the prediction unit 35 calculates the temporal change in the total use amount of the resource to be used in the future by the containers 11-1 to 11-N from the prediction result indicated by the output data ODₙ.

The prediction unit 35 outputs the total resource use amount uₜₒₜₐₗ(t) to the container deleting unit 33 as a temporal change in the total use amount of the resource.

Similarly to the resource management device 12 illustrated in FIG. 2, the resource management device 12 illustrated in FIG, 7 can suppress the total of resource use amounts by the containers 11-1 to 11-N included in the node 2 to be equal to or less than the total of the resources of the node 2 while suppressing the surplus of the resources of the node 2.

Further, the resource management device 12 illustrated in FIG. 7 can obtain a prediction result corresponding to the monitoring data MDₙ even if there is no periodicity in the use amount of the resource used in the past by the container 11-n (n=1, . . . , N).

In the resource management device 12 illustrated in FIG. 7, at the time of learning, the monitoring data MDₙ indicating the temporal change in the use amount of the resource used in the past by the container 11-n (n=1, . . . , N) and the training data GDₙ indicating the temporal change in the use amount of the resource to be used in the future by the container 11-n are given to the learning model 34. Then, the learning model 34 updates the weighting factor of the neural network in such a manner that the output data ODₙ indicating the prediction result when the monitoring data MDₙ is given becomes the temporal change in the use amount indicated by the training data GDₙ.

However, this is merely an example, and monitoring data MDₙ′ may be given to the learning model 34 in addition to the monitoring data MDₙ and the training data GDₙ at the time of learning. The monitoring data MDₙ′ indicates a temporal change in the use amount of the resource used in the past by a container among the containers 11-1 to 11-N different from the container 11-n.

The learning model 34 updates the weighting factor of the neural network in such a manner that the output data ODₙ indicating the prediction result when the monitoring data MDₙ and the monitoring data MDₙ′ are given becomes the temporal change in the use amount indicated by the training data GDₙ.

The prediction unit 35 gives the monitoring data MDₙ and the monitoring data MDₙ′ to the learning model 34, and acquires the output data ODₙ indicating the prediction result from the learning model 34.

The temporal change in the monitoring data MDₙ and the temporal change in the monitoring data MDₙ′ may affect each other. In such a case, at the time of inference, the prediction unit 35 may obtain a highly accurate prediction result from the learning model 34 by giving the monitoring data MDₙ and the monitoring data MDₙ′ to the learning model 34 rather than giving only the monitoring data MDₙ to the learning model 34.

### Third Embodiment

In a third embodiment, a resource management device 12 in which a prediction unit 36 extracts, from each piece of monitoring data MD₁ to MD_{N} acquired by a data acquiring unit 31, a part of the data when a state of the node 2 is the same state will be described.

FIG. 9 is a configuration diagram illustrating the resource management device 12 according to the third embodiment. In FIG. 9, the same reference numerals as those in FIGS. 2 and 7 denote the same or corresponding parts, and thus description thereof is omitted.

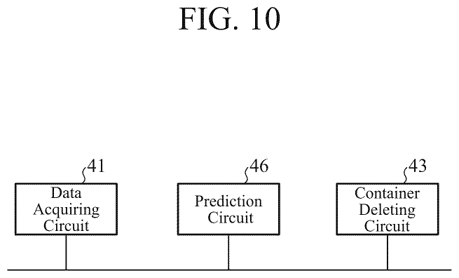

FIG. 10 is a hardware configuration diagram illustrating hardware of the resource management device 12 according to the third embodiment. In FIG. 10, the same reference numerals as those in FIGS. 3 and 8 denote the same or corresponding parts, and thus description thereof is omitted.

The resource management device 12 illustrated in FIG. 9 includes the data acquiring unit 31, the prediction unit 36, and a container deleting unit 33.

The configuration of the node 2 including the resource management device 12 illustrated in FIG. 9 is similar to the configuration of the node 2 including the resource management device 12 illustrated in FIG. 2, and the configuration diagram illustrating the node 2 including the resource management device 12 illustrated in FIG. 9 is illustrated in FIG. 1.

The prediction unit 36 is implemented by, for example, a prediction circuit 46 illustrated in FIG. 10.

The prediction unit 36 acquires the monitoring data MDₙ (n=1, . . . , N) from the data acquiring unit 31.

The prediction unit 36 extracts, from each piece of the monitoring data MD₁ to MD_{N}, a part of the data when the state of the node 2 is the same state.

An example of a part of data when the state of the node 2 is the same state is a part of data when the state of movement of the node 2 is the same state, a part of data when the operating state of the node 2 is the same state, or a part of data when the state of another system connected to the node 2 is the same state.

An example of the state of movement of the node 2 is a state in which the node 2 is moving at a high speed, a state in which the node 2 is moving at a medium speed, a state in which the node 2 is moving at a low speed, or a state in which the node 2 is stopped.

An example of the operating state of the node 2 is an activated state in which the node 2 is activated, a normal state in which the activation of the node 2 is completed, a safe mode state in which the node 2 is operating in the safe mode, a sleep state in which the operation of the node 2 is paused, or an end state in which the operation of the node 2 is ended.

An example of the state of the other system connected to the node 2 is a state of movement of the other system or an operating state of the other system, An example of the other system is a communication system connected to the node 2 or an in-vehicle system connected to the node 2.

The prediction unit 36 predicts the temporal change in the use amount of the resource to be used in the future by the container 11-n from each part of the data.

Similarly to the prediction unit 32 illustrated in FIG. 2, the prediction unit 36 calculates, from the prediction result of the temporal change, the temporal change in the total use amount of the resource to be used in the future by the containers 11-1 to 11-N.

In FIG. 9, it is assumed that each of the data acquiring unit 31, the prediction unit 36, and the container deleting unit 33 which are components of the resource management device 12 is implemented by dedicated hardware as illustrated in FIG. 10. That is, it is assumed that the resource management device 12 is implemented by the data acquiring circuit 41, the prediction circuit 46, and the container deleting circuit 43.

Each of the data acquiring circuit 41, the prediction circuit 46, and the container deleting circuit 43 corresponds to, for example, a single circuit, a composite circuit, a programmed processor, a parallel-programmed processor, ASIC, FPGA, or a combination thereof.

The components of the resource management device 12 are not limited to those implemented by dedicated hardware, and the resource management device 12 may be implemented by software, firmware, or a combination of software and firmware.

In a case where the resource management device 12 is implemented by software, firmware, or the like, a program for causing a computer to execute each processing procedure performed in the data acquiring unit 31, the prediction unit 36, and the container deleting unit 33 is stored in the memory 51 illustrated in FIG. 4. Then, the processor 52 illustrated in FIG. 4 executes the program stored in the memory 51.

Furthermore, FIG. 10 illustrates an example in which each of the components of the resource management device 12 is implemented by dedicated hardware, and FIG. 4 illustrates an example in which the resource management device 12 is implemented by software, firmware, or the like. However, this is merely an example, and some components in the resource management device 12 may be implemented by dedicated hardware, and the remaining components may be implemented by software, firmware, or the like.

Next, an operation of the resource management device 12 illustrated in FIG. 9 will be described. Since the components other than the prediction unit 36 are similar to those of the resource management device 12 illustrated in FIG. 2, only operation of the prediction unit 36 will be described here.

The prediction unit 36 acquires the monitoring data MDₙ (n=1, . . . , N) from the data acquiring unit 31.

The prediction unit 36 extracts, from each piece of the monitoring data MD₁ to MD_{N}, a part of the data when the state of the node 2 is the same state.

That is, the prediction unit 36 extracts, from each piece of the monitoring data MD₁ to MD_{N}, as a part of the data when the state of the node 2 is the same state, for example, a part of the data when the state of movement of the node 2 is the same state, a part of the data when the operating state of the node 2 is the same state, or a part of the data when the state of another system connected to the node 2 is the same state.

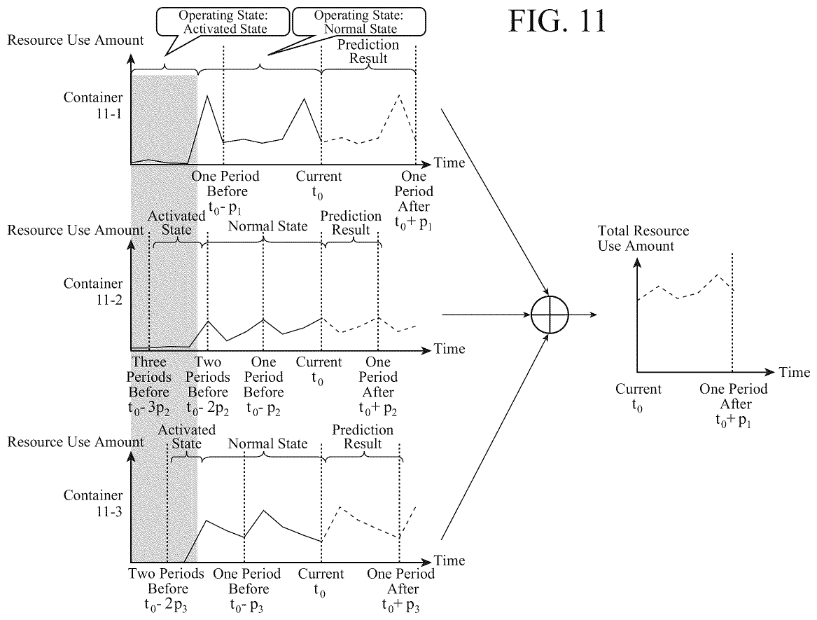

FIG. 11 is an explanatory diagram illustrating an example in which the prediction unit 36 extracts, from each piece of the monitoring data MD₁ to MD_{N}, a part of the data when the operating state of the node 2 is the same state.

In the example of FIG. 11, data when the operating state of the node 2 is the normal state is extracted from each piece of the monitoring data MD₁ to MD₃.

The prediction unit 36 predicts a temporal change in the use amount of the resource to be used in the future by the container 11-n from a part of data included in the monitoring data MDₙ. In the example of FIG. 11, the part of data is data when the operating state of the node 2 is the normal state.

Since the prediction processing by the prediction unit 36 itself is similar to the prediction processing by the prediction unit 32 illustrated in FIG. 2, detailed description thereof will be omitted.

Similarly to the prediction unit 32 illustrated in FIG. 2, the prediction unit 36 calculates, from the prediction result of the temporal change, the temporal change in the total use amount of the resource to be used in the future by the containers 11-1 to 11-N.

In the resource management device 12 illustrated in FIG. 9, since the prediction unit 36 predicts the temporal change in the use amount of the resource to be used in the future by the container 11-n from a part of data when the state of the node 2 is the same state, prediction accuracy may be improved as compared with the prediction unit 32 illustrated in FIG. 2.

In the resource management device 12 illustrated in FIG. 9, the prediction unit 36 extracts, from each piece of the monitoring data MD₁ to MD_{N}, a part of the data when the state of the node 2 is the same state. However, this is merely an example, and the prediction unit 36 may extract, from each piece of the monitoring data MD₁ to MD_{N}, a part of the data when the environment of the node 2 is the same environment.

An example of the part of the data when the environment of the node 2 is the same environment is a part of data when an environment related to weather around the node 2 is the same environment, or a part of data when an environment related to a use time of the resource is the same environment.

An example of the environment related to the weather around the node 2 is an environment in which the weather is sunny, an environment in which the weather is rainy, an environment in which the weather is cloudy, or an environment in which the weather is snowy.

An example of the environment related to the use time of the resource is an environment in which the use time of the resource is included in the morning time period, an environment in which the use time of the resource is included in the daytime time period, an environment in which the use time of the resource is included in the evening time period, or an environment in which the use time of the resource is included in the night time period.

Also in this case, the prediction unit 36 predicts a temporal change in the use amount of the resource to be used in the future by the container 11-n from a part of data included in the monitoring data MDₙ.

Note that, in the present disclosure, free combinations of the embodiments, modifications of any components of the embodiments, or omissions of any components in the embodiments are possible.

### INDUSTRIAL APPLICABILITY

The present disclosure is suitable for a resource management device and a resource management method.

### Reference Signs List

1: container distribution server, 2: node, 11-1 to 11-N: container, 12: resource management device, 13: OS, 14: container runtime, 31: data acquiring unit, 32: prediction unit, 33: container deleting unit, 34: learning model, 35: prediction unit, 36: prediction unit, 41: data acquiring circuit, 42: prediction circuit, 43: container deleting circuit, 44: learning circuit, 45: prediction circuit, 46: prediction circuit, 51: memory, 52: processor

1. A resource management device, comprising:
data acquiring circuitry to acquire monitoring data indicating a temporal change in a use amount of a resource used in a past by each of one or more containers included in a node among at least one resource of the node;
prediction circuitry to predict a temporal change in a use amount of the resource to be used in a future by each of the containers from a corresponding one of pieces of the monitoring data acquired by the data acquiring circuitry, and calculate a temporal change in a total use amount of the resource to be used in the future by the one or more containers from a prediction result of the temporal change; and
container deleting circuitry to delete one of the one or more containers when a timing at which the total use amount of the resource becomes larger than a total of the resource of the node is included in the temporal change in the total use amount of the resource calculated by the prediction circuitry, wherein
the prediction circuitry
predicts, when there is no periodicity in the use amount of the resource used in the past by each of the containers, the temporal change in the use amount of the resource to be used in the future by each of the containers on a basis of a peak value of the use amount of the resource used in the past by a corresponding one of the containers,
the prediction circuitry
calculates, when there is a plurality of containers having no periodicity in the use amount of the resource used in the past among the one or more containers, a correlation coefficient between use amounts of the resource used in the past by the respective plurality of containers, and specifies, when the correlation coefficient is a negative correlation, a container having a highest peak value of the use amount of the resource used in the past among the plurality of containers, and
the total use amount of the resource to be used in the future by the one or more containers includes a use amount of the resource to be used in the future by the specified container and does not include a use amount of the resource to be used in the future by a container other than the specified container among the plurality of containers.

2. The resource management device according to claim 1, wherein,
the prediction circuitry
detects a period of the use amount of the resource used in the past by each of the containers from the corresponding one of pieces of the monitoring data acquired by the data acquiring circuitry, and predicts the temporal change in the use amount of the resource to be used in the future by each of the containers on a basis of a temporal change in the use amount within the period.

3. The resource management device according to claim 2, wherein
the prediction circuitry
calculates a plurality of autocorrelation functions having different delay times from each of pieces of the monitoring data acquired by the data acquiring circuitry as an autocorrelation function for the use amount of the resource used in the past by a corresponding one of the containers, and specifies a delay time of an autocorrelation function having a highest positive correlation among the plurality of autocorrelation functions as the period of the use amount.

4-5. (canceled)

6. The resource management device according to claim 1, wherein
the prediction circuitry
gives the temporal change in the use amount of the resource used in the past by each of the containers to a learning model, and acquires the prediction result of the temporal change in the use amount of the resource to be used in the future by each of the containers from the learning model.

7. The resource management device according to claim 1, wherein
the prediction circuitry
gives the temporal change in the use amount of the resource used in the past by each of the containers and a temporal change in a use amount of the resource used in the past by a container different from the each of the containers to a learning model, and acquires the prediction result of the temporal change in the use amount of the resource to be used in the future by each of the containers from the learning model.

8. A resource management device, comprising:
data acquiring circuitry to acquire monitoring data indicating a temporal change in a use amount of a resource used in a past by each of one or more containers included in a node among at least one resource of the node;
prediction circuitry to predict a temporal change in a use amount of the resource to be used in a future by each of the containers from a corresponding one of pieces of the monitoring data acquired by the data acquiring circuitry, and calculate a temporal change in a total use amount of the resource to be used in the future by the one or more containers from a prediction result of the temporal change; and
container deleting circuitry to delete one of the one or more containers when a timing at which the total use amount of the resource becomes larger than a total of the resource of the node is included in the temporal change in the total use amount of the resource calculated by the prediction circuitry, wherein
the prediction circuitry
extracts a part of data when a state of the node is a same state or when an environment of the node is a same environment from each of one or more pieces of the monitoring data acquired by the data acquiring circuitry, and predicts the temporal change in the use amount of the resource to be used in the future by each of the containers from each part of the data.

9. (canceled)

10. The resource management device according to claim 8, wherein
the prediction circuitry
extracts a part of data when a state of movement of the node is a same state as the part of data when the state of the node is the same state from each of the one or more pieces of the monitoring data acquired by the data acquiring circuitry.

11. The resource management device according to claim 8, wherein
the prediction circuitry
extracts a part of data when an operating state of the node is a same state as the part of data when the state of the node is the same state from each of the one or more pieces of the monitoring data acquired by the data acquiring circuitry.

12. The resource management device according to claim 8, wherein
the prediction circuitry
extracts a part of data when a state of another system connected to the node is a same state as the part of data when the state of the node is the same state from each of the one or more pieces of the monitoring data acquired by the data acquiring circuitry.

13. The resource management device according to claim 8, wherein
the prediction circuitry
extracts a part of data when an environment related to weather around the node is a same environment as the part of data when the environment of the node is the same environment from each of the one or more pieces of the monitoring data acquired by the data acquiring circuitry.

14. The resource management device according to claim 8, wherein
the prediction circuitry
extracts a part of data when an environment related to a use time of the resource is a same environment as the part of data when the environment of the node is the same environment from each of the one or more pieces of the monitoring data acquired by the data acquiring circuitry.

15. The resource management device according to claim 8, wherein
the container deleting circuitry
determines, when the timing at which the total use amount of the resource becomes larger than the total of the resource of the node is included in the temporal change in the total use amount of the resource calculated by the prediction circuitry, a container to be deleted on a basis of a use amount of the resource of each of the containers at the timing.

16. The resource management device according to claim 8, wherein
the container deleting circuitry
determines, when the timing at which the total use amount of the resource becomes larger than the total of the resource of the node is included in the temporal change in the total use amount of the resource calculated by the prediction circuitry, a container to be deleted on a basis of a time at which each of the containers is distributed to the node.

17. The resource management device according to claim 8, wherein
the container deleting circuitry
determines, when the timing at which the total use amount of the resource becomes larger than the total of the resource of the node is included in the temporal change in the total use amount of the resource calculated by the prediction circuitry, a container to be deleted on a basis of an operation priority of each of the containers.

18. The resource management device according to claim 8, wherein
the container deleting circuitry
determines, when the timing at which the total use amount of the resource becomes larger than the total of the resource of the node is included in the temporal change in the total use amount of the resource calculated by the prediction circuitry, a container to be deleted on a basis of a use amount of the resource of each of the containers at the timing, a time at which each of the containers is distributed to the node, and an operation priority of each of the containers.

19. The resource management device according to claim 8, wherein the use amount of the resource of the node is a use rate of a central processing unit (CPU) of the node, a use amount of a memory of the node, a use amount of a storage of the node, a bandwidth use rate of a network connected to the node, or a use rate of a device connected to the node.

20. A resource management method comprising:
acquiring monitoring data indicating a temporal change in a use amount of a resource used in a past by each of one or more containers included in a node among at least one resource of the node;
predicting a temporal change in a use amount of the resource to be used in a future by each of the containers from a corresponding one of pieces of the monitoring data, and calculating a temporal change in a total use amount of the resource to be used in the future by the one or more containers from a prediction result of the temporal change;
deleting one of the one or more containers when a timing at which the total use amount of the resource becomes larger than a total of the resource of the node is included in the temporal change in the total use amount of the resource; and
extracting a part of data when a state of the node is a same state or when an environment of the node is a same environment from each of one or more pieces of the monitoring data, and predicting the temporal change in the use amount of the resource to be used in the future by each of the containers from each part of the data.

21. The resource management device according to claim 1, wherein
the container deleting circuitry
determines, when the timing at which the total use amount of the resource becomes larger than the total of the resource of the node is included in the temporal change in the total use amount of the resource calculated by the prediction circuitry, a container to be deleted on a basis of a time at which each of the containers is distributed to the node.

22. The resource management device according to claim 1, wherein
the container deleting circuitry
determines, when the timing at which the total use amount of the resource becomes larger than the total of the resource of the node is included in the temporal change in the total use amount of the resource calculated by the prediction circuitry, a container to be deleted on a basis of a use amount of the resource of each of the containers at the timing, a time at which each of the containers is distributed to the node, and an operation priority of each of the containers.
